(19) United States
(12) Patent Application Publication
(10) Pub. No.: US 2008/0040138 A1
(43) Pub. Date: Feb. 14, 2008

(54) Telephone Number Stamps

(76) Inventors: Udo Hinz, Stockholm-Spanga (SE); Anders Bjorhn, Lidingo (SE); Adrian Hinz, Stockholm-Spanga (SE)

Correspondence Address: DRINKER BIDDLE & REATH (DC), 1500 K STREET, N.W., SUITE 1100, WASHINGTON, DC, 20005-1209, US

(21) Appl. No.: 11/666,321

(22) PCT Filed: Oct. 25, 2005
(86) PCT No.: PCT/SE05/01594

§ 371 Date: Sep. 24, 2007

(30) Foreign Application Priority Data
Oct. 25, 2004 (SE) 0402574-8
Nov. 1, 2004 (US) 10/977135
Mar. 14, 2005 (SE) 0500565-7
Apr. 19, 2005 (US) 11/108893
Sep. 12, 2005 (SE) 0502006-0

(51) Int. Cl. G06Q 50/00; G06F 17/30; G06F 17/40

(52) U.S. Cl. 705/1

(57) ABSTRACT

The invention regards a method, a system and a package for payment and granting of postage rate for an item of mailing (10) through at least one of a network for data- and telecommunication. The item of mailing (10) is marked up with a telephone number (12) belonging to the mailer, and the mailer calls a pre-determined telephone number (14) to the distributor of items of mailing (10), thus through the pre-determined telephone number (14) confirming postage rate and payment of an item of mailing (10) at the distributor of mail.

### TECHNICAL FIELD

The present invention pertains to a method, a system and a package regarding payment and acceptance of postage rate for postage of an item of mailing through at least one of a network of data and telecommunications.

### BACKGROUND ART

Postage of an item of mail such as an envelope, packet/parcel, picture postcard and others, which are dispatched by mail distribution are provided with stamps and/or consignment notes, which are glued on the item of mail. Before the item of mail are dispatched through the mail delivery the stamps are and/or the consignment notes are stamped by the distributor of mail, for instance the post office, by machinery or manually.

The problem for the average person is that stamps and consignments notes seldom are at reach when they are needed. There are few points-of-sale, which are selling postage items, and if so is not the case they rarely keep an entire range of postage rates.

A person who would like to post an item of mail thus has to pre-purchase postage or purchase it afterwards. As people live a busy life with claims from employment and family and other doings, it is rare to plan every day life so that stamps or consignment notes are available. This leads to that an item of postage can be forgotten in days and weeks before it is posted. Unfortunately, thus important time deadlines may be abandoned, and other unnecessary tasks can arise. Find a point-of-sale for stamps is not easy and often demands a shorter or longer trip with a car, and if it is evening most point-of-sales are closed.

Additionally, business owners pay for franking machines through agreements with the postal authorities, which can cost more than SEK 6000 pro year only for rental. Furthermore, the business owner that rents franking machines has to have an agreement to fill up an assigned account for franking.

Patent application document GB 2 387 259 A provides a method to receive a postage verification code to adhere to an item of postage. The code is received by sending an SMS, HTML or other message such as PSTN push button messages to a postal server, whereby the postal server utilizes the information comprised in the message to create the verification code, whereby the information in the SMS message can comprise a telephone number. When the code has been determined through an algorithm which operates on the information, e.g. telephone number, in the verification code request SMS message or other message in the server, the verification code is transmitted to the person making the request. This means that no data such as a telephone number per se is put on an item of postage, and a rather time consuming SMS or other message request has to be addressed to the postal server before being able to put a valid identifier for a postage on for instance a letter. Document GB 2 387 259 A does not recognize or teach that a telephone number per se is a unique identifier to a person or company.

Hence, there is a need for an alternative to stamps and consignment notes for franking of items for postage, which is easier within reach for the average person.

### SUMMARY OF THE INVENTION

The present invention has as an aim out of a plurality of others to present a replacement to stamps and consignment notes for items of mailing in such a manner that the postage rate or value for franking does not have to be stated in the shape of currency on items of mailing viewed from the point of view of the mailers position for posting items of mailing. Furthermore, the invention as another aim provides that stamps are replaced, whereby an item of mailing is marked with handwritten data in an array or matrix pattern for scanning by suitable machinery.

If the present invention marking up of items of mailing/postage is utilized any terrorist or person who sends threatening mails, mail bombs, poison or the like has to present a telephone number as a substitution for a stamp, and the mailer is thus traceable in some manner, at least for the origin of the item of mailing.

To accomplish what is mentioned and other advantages, the present invention sets forth a method relating to payment and granting of postage rate for items of mailing through at least one of a network for data- and telecommunication. An item of mailing is marked up with a telephone number on which a mailer subscribes to, and that the mailer calls a predetermined telephone number belonging to the distributor of the items of mailing, confirming by the predetermined telephone number the payment of an item of mailing at the distributor, whereby said calling is registered in a database for distribution of mail associated to the predetermined telephone number and to the telephone number of the mailer, said items of mail read by a machinery during distribution where data registered in said database through the mailers telephone number is checked for correspondence with data marked up and read on the item of mailing regarding postage rate and payment, by correspondence between data, the item of mailing being granted for distribution.

One embodiment of the present invention comprises that the pattern is an array or matrix to be filled in with a mailers/callers/forwarders/customers telephone number.

In another embodiment it comprises that the array or matrix pattern is further marked up with the time or other received code for the calling by the mailer with the own telephone number.

Another embodiment comprises that the array or matrix pattern is comprised by markings to be filled in, which when they are filled in resemble the telephone number which the mailer subscribes to.

A still further embodiment comprises that the filled in markings are different in number for every figure between zeros to nine so that the figures are identified by the number of filled in markings through pattern recognition or differences in reflectance when scanned.

Yet another embodiment comprises that the array or matrix pattern consists of markings to be filled in or filled in markings, which when they are combined by straight lines resembles the telephone number subscribed to by the mailer.

Furthermore, an embodiment comprises that the scanner is a light beam scanner, whereby the beam is inclined in such a manner that both perpendicular and transversal lines are registered in its entirety when the scanner beam is moved over the array pattern.

Yet a further embodiment comprises that the telephone number of the mailer is an IP telephony number.

A still further embodiment comprises that different postage rates for mailing have there own predetermined telephone number which is called by the mailer for posting.

A further embodiment comprises that said item of mailing is marked up with data pre-printed in the shape of an EAN code or like barcode for machine reading.

Yet a still further embodiment comprises that stacks of multiple items of mailing are replacing the franking machine.

Furthermore, the present invention sets forth a system relating to payment and granting of postage rate for items of mailing through at least one of a network for data- and telecommunication. The system comprises that:

an item of mailing is marked up with a telephone number on which a mailer subscribes to, and that the mailer calls a predetermined telephone number belonging to the distributor of the items of mailing, confirming by the predetermined telephone number the payment of an item of mailing at the distributor;

said calling is registered in a database for distribution of mail associated to the predetermined telephone number and to the telephone number of the mailer; and

said items of mailing read by a machinery during distribution where data registered in said database through the mailers telephone number is checked for correspondence with data marked up and read on the item of mail regarding postage rate and payment, by correspondence between data, the item of mailing being granted for distribution.

Moreover, the present invention comprises a package for items of mailing regarding payment and granting of postage for items of mailing through at least one of a network for data and telecommunication. The package is marked with an array pattern intended for filling in a telephone number, which a mailer/forwarder subscribes to, with figures, visible to the human eyes, and identifiable for machine scanning. The telephone number identifies a mailer by the same telephone number being stored in a database at a distributor of items of mailing.

Furthermore, the system and the package of the present invention comprise further embodiments in accordance with the embodiments of the above described method according to the attached dependent system and package claims.

### BRIEF DESCRIPTION OF THE DRAWINGS

Henceforth reference is had to the attached figures in the accompanying text of the description for a better understanding of the present invention with its embodiments and given examples, wherein:

FIG. 1 illustrates one embodiment for franking/marking up of items of mailing in accordance with the present invention;

FIG. 2 illustrates one further embodiment for franking/marking up of items of mailing in accordance with the present invention;

FIG. 3 illustrates a still further embodiment for franking/marking up of items of mailing in accordance with the present invention;

FIG. 4 illustrates a still further embodiment for franking/marking up of items of mailing with a label comprising an array or matrix pattern in accordance with the present invention;

FIG. 5 illustrates another embodiment for franking/marking up of items of mailing with a label comprising an array or matrix pattern in accordance with the present invention;

FIG. 6 schematically illustrates a circle array for franking/marking up of items of mailing in accordance with an embodiment of the present invention;

FIG. 7 illustrates an embodiment of a package for an item of mailing which has been provided a label comprising an array or matrix pattern for franking/marking of the item in accordance with the present invention;

FIG. 8 schematically illustrates a system for franking/marking up of items of mailing in accordance with the present invention;

FIG. 9 schematically illustrates an embodiment for payment of parking fees;

FIG. 10 schematically illustrates how a securer payment of goods and services is accomplished over Internet; and

FIG. 11 schematically illustrates a cellular phone marked with its own telephone number.

### DETAILED DESCRIPTION OF PREFERRED EMBODIMENTS

The present invention firstly states an alternative or replacement to franking of items of mailing with stamps and/or documents of consignment. The expression franking usually used to express attaching of a stamp to an item of mailing is herein referred to marking up an item of mailing with a label, printed or handwritten data. To accomplish this an item of mailing such as a letter, postcard, packet/parcel and others is marked up/franked with at least a telephone number, in one embodiment of the present invention, whereby a person (mailer) that is to post or send an item of mailing is a subscriber to the telephone number. The telephone number can be connected to a cellular network such as GSM, CDMA, WCDMA or any other in the market appropriate mobile or cellular system. Also a telephone number having a subscription belonging to the public telephony system PSTN (Public Switched Telephone Network) can be utilized to franking of items of mailing. Henceforth, for sake of simplicity, the expression letter is often used for an item of mailing, but the present invention is as useful for all kinds of items of mailing which are distributed via post distribution.

In a first embodiment of the present invention a letter is franked with one of a mailers telephone numbers, as for instance the fictive telephone number 0123456789, whereby the mailer calls a pre-determined telephone number, fictive, for example, 9876543210, at or belonging to an operator for distribution of post such as the Post®, CityMail®, DHL, FedEx®, UPC® or other corresponding foreign distributors of post such as Deutsche Post®, Danza®, USMail® or other entrepreneurs for distribution of items of mailing. A list of such distributors of mailing can be made long. When the call/dialling is registered in a database at the distributor of mail, the call is registered at the telephone operator, and a specific amount for the postage rate is added, in one embodiment of the present invention, to the telephone bill (billing) for the subscription 0123456789.

The postage rate and its value can in one embodiment of the invention be determined through push button keying on the mailers telephone, through voice prompting or that it exists one telephone number at the distributor of mail for each postage rate for franking. If for instance a mailer would like to post 5, 10, 15, 20, 25 . . . items of mailing of the same postage rate, for example, to post Christmas or Easter cards, it is possible in one embodiment to utilize a single telephone number belonging to/for the distributor of mail for each multiple of items of mailing so that the correct debiting is added to the telephone bill. The multiple items of mailing are decremented as soon they are matched against the database, or for instance all companies telephone numbers are registered in a stack for the number of franking that are wanted for the time being.

This method replaces a franking machine, and the franking machine is always available when the company would like to use it, according to the terms of the company. In order to secure that none authorized persons/companies can fraud on the mailing every letter can have a unique code either given every item of mailing at the company and stored in the distributor's database when making the call or given by the distributor. The new franking machine according to the present invention in one embodiment is equipped with an ink jet printer with inbuilt telephony equipment, a processor, memory and for instance a random number generator generating a specific code for every item of mailing posted by the specific company. Thus the telephone calls the number given by the distributor for a stack of for instance 100 mailings, whereby the random generator calculates 100 random codes each one for every letter to be posted, which are registered together with the calling companies telephone number in a database at a distributor of mail. The posted letters are then granted when scanned if the telephone number and given codes connected to the telephone number exist in the database stack.

In one embodiment of the present invention an income of the distributor of mail is deducted from the telephone bill through agreement between the operator of the telephone network, e.g. Telia®, Vodafone®, Tele2®, Comviq®, Orange®, Tre®, Qualcom®, Mannesmann®, T . . . Com® and other corresponding telephone operators. The telephone number can be handwritten with, e.g. ball pen, felt pen or the like on the letter in one embodiment of the present invention, for example, where conventionally the stamp is glued/adhered on an envelope or packet/parcel, but the position for the telephone number can of course be standardized to another position on the item of mailing.

When the distributor of mail, via mailing of the letter, sorts it by machinery for the checking of a correct franking, the letter is read/scanned with the franked/marked up telephone number, whereby it is checked in the database at the distributor of mail that the item of mailing is correctly franked/marked up, and if this is the case a marking of payment in the database is zeroed, and the item of mailing is granted for distribution to the intended addressee.

In this first embodiment of the present invention the situation may arise that some one by fraud boroughs the telephone of a subscriber to register a postage rate with a value in the database at the distributor of mail, but a person skilled in the art recognizes that the probability for this or the damage with such a procedure is minimal. Although, such an unlawful approach can be prevented or minimized, which will be apparent through the continued description of further embodiments of the present invention. It is also possible to randomly write some ones telephone number on a letter, but this is rarely successful if the owner or subscribers to the borrowed telephone number him- or she has not called in and registered in the database at the distributor of mail. The item of mailing is then not granted when it is read by machinery at the distributor of mail.

The skilled person within the present technical field knows that there exists software on the current market, which can read handwritten information from material such as paper, card board and other materials in accordance with the above for distribution of post.

In one embodiment of the present invention, the mailer is able to, through for instance Internet, order labels with pre-printed telephone numbers from the distributor of mail or from a printing house, and other data which henceforth will be presented, which are attached by, e.g. being glued to the item of mailing. It is also possible to code telephone numbers and other data, which is presented below through EAN code labels and other like barcode standards for attachment to items of mailing, 2D matrixes for attachment to items of mailing. 2D matrixes are known to the person skilled in the art, and are not further elaborated herein. Furthermore, the pre-printed labels could comprise pictures as usual stamps, but with the mailers telephone number pre-printed, and other data as follows below. Labels in accordance with the present invention can in one embodiment also be manufactured in the shape of RFID labels (Radio Frequency Identity), so called “smart labels”, with telephone numbers and other data so that scanning apparatuses for RFID can be utilized when reading items of mailing in a manner known to a person skilled in the art. Information regarding RFID labels in for instance passports can be retrieved from Big Brother Bulletin, No. 13, 2004,” Nya pass strålar information till obehöriga med radiovågor”, (New passports radiate information to unauthorized with radio vawes) BIG-BROTHER-BULLETIN@PEACH.EASE.LSOFT.COM.

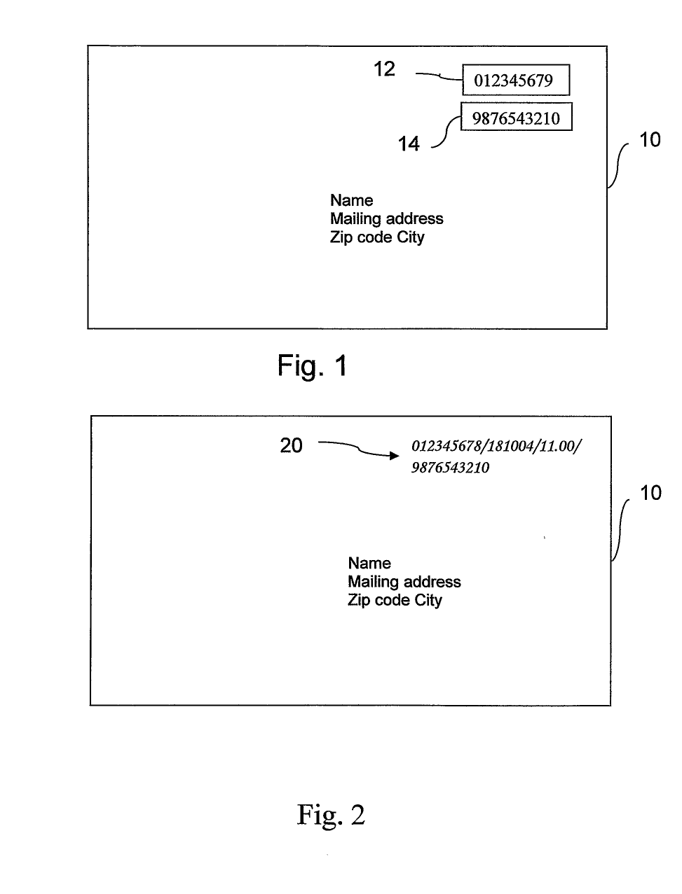

FIG. 1 illustrates an embodiment for franking/marking up of items of mailing in accordance with the present invention. In FIG. 1 an item of mailing 10 one side face is shown, e.g. a letter, where name, mailing address, zip code, and city is stated, herein shown as assumed to be provided, and the mailers telephone number 12 (0123456789) has been adhered to the letter as a label. Also, the telephone number 14 (9876543210) which the mailer calls to register postage rate and payment at the distributor of mail has been adhered to the letter.

The payment is added the mailers telephone bill. Either, the postage rate that corresponds to the telephone number which has been called in accordance with the above is registered, or the postage rate is registered through voice prompting with push button keying on the mailers telephone. In this case, after that the item of mailing 10 has been read, the registering is found in the database through the mailers telephone number 12 or through the distributor of posts telephone number 14 for postage rate. The present invention does not specifically state how storing in a database is accomplished, but it is to understand that the person skilled in the art within this technical field is utilizing well known methods for storing in a database.

FIG. 2 illustrates a further embodiment of franking/marking up of items of mailing in accordance with the present invention, where data 20 for franking of the letter 10 has been handwritten, with a slash between different fields. In the first field from the left, the mailers telephone number, 0123456789, is stated, and in the next field behind the first slash, the date, 181004, i.e., Oct. 18, 2004, has been stated for franking. Thereafter, the time, 11.00, for the call to the distributor of mail has been attached in the next field, and behind the last slash, the telephone number, 9876543210, to the distributor of mail has been stated. When calling the telephone number to the distributor of mail, the telephone number of the mailer, time, and date has of course been registered in the database. The reading, when the item of mailing 10 has been posted, matches data on the item of mailing 10 with data stored in the database at the distributor of mail for granting and distribution of the item of mailing. The time can be deducted by own watch or through voice by the call. In this manner it is almost impossible for another mailer to cheat by stating another telephone number in accordance with what has been described above. The person skilled in the art realizes that data 20 being adhered to the item of mailing 10 can be stated in an arbitrary order for reading, and that other markers then slash can be utilized for partitioning of fields. The numbers can also be marked up in a continuous order for machinery reading. A favourable method in implementing the present invention would be if the order of attachment to the item of mailing 10 is standardized.

Concerning the time 11.00, it does not have to be exactly, but can be truncated or rounded off within an interval of e.g. 5 minutes or within another suitable number of minutes, for example, if it is assumed that the call was made 10.55, then the time can be registered as 10.50 or 11.00 depending on the convention, truncating or rounding off.

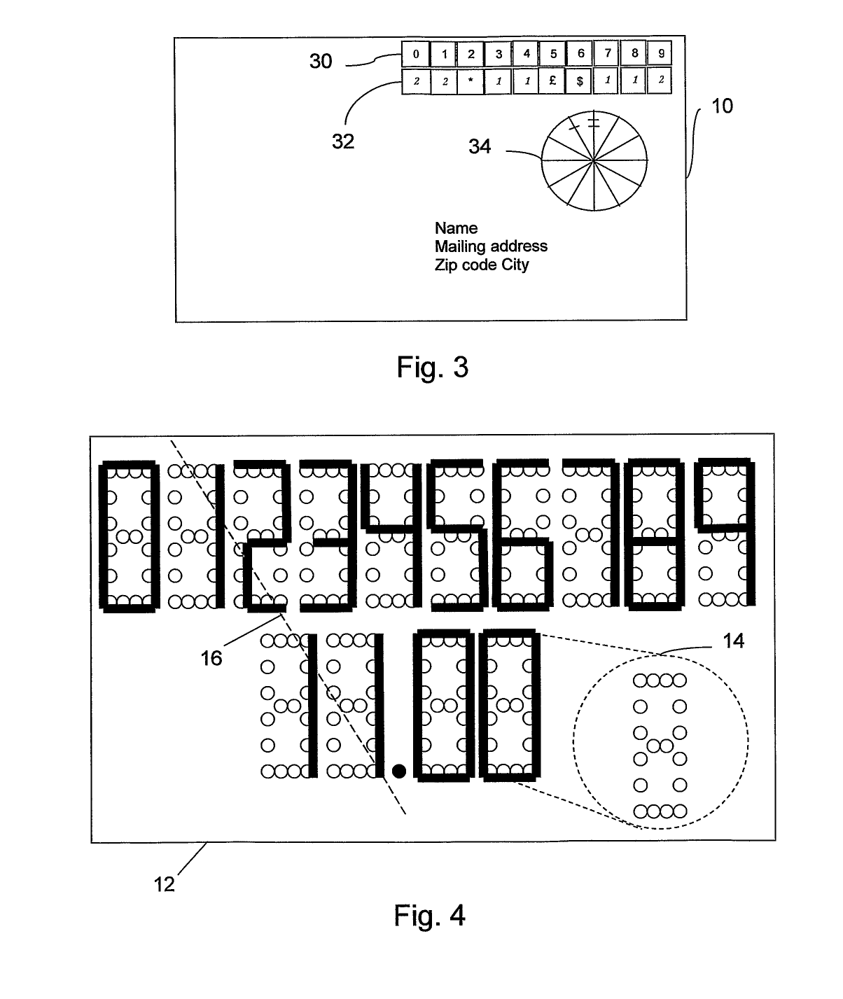

FIG. 3 illustrates yet another embodiment of franking/marking up of items of mailing in accordance with the present invention. In this embodiment, two square patterns 30, 32, have, either been pre-printed on the item of mailing 10 or being adhered as a label. The square pattern 30 states numbers from 0-9, not to be miss-interpreted as the mailers telephone number according to the above, but with the square pattern 32, the telephone number of the mailer has been marked up as consisting of two zeros, two number ones, one number three, one number four, one number seven, one number eight, and two number nines. The telephone number which the mailer subscribes to is thus not directly to be seen, but the number of each figure appears. The telephone number is for instance 0708913941 (cellular phone number) or another with the same figures. In the database at the distributor of mail the figures can be checked when reading against the telephone number that was used when calling in for registration of postage rate and payment, by for instance every figure in a series composing the registering number 2211112 or in another suitable manner, for example, by marking up figures that do not appear in the telephone number in accordance with e.g. 22*11£$112, by reading the same. The marking up of non appearing figures can be keyed by the mailer via voice prompting when calling, as e.g. 22*11£$112, see FIG. 3, whereby the non appearing characters with great probability will differ from another telephone number with the same series of figures.

The number of square patterns is not limited to two 30, 32 as in the present embodiment. If the series of figures 2211112 is utilized for storing in the database, in one embodiment, when calling information of the addressee may be stored together with the series of figures, so that identification/matching is unique, i.e., if the same series of figures 2211112 would appear in multiple examples as entry to a post in the database, e.g. the name of the addressee composes a correct matching. This assumes that the name is read together with the series of figures.

The square pattern can in another shape be pre-printed on the item of mailing in accordance, with for example, trot coupons to the Swedish V-75 game with bar markings easily readable by machinery. So called 2D matrixes can also be utilized for the present invention.

In FIG. 3 is also illustrated a fictive clock 34, e.g. adhered as a label, where the time for registration in the database can be marked up for instance by marking the small hand with one line and the big hand with two big lines, or in another similar manner under the convention that the clock is read clockwise, whereby the time is registered as 11.00 during reading.

FIG. 4 illustrates an embodiment of franking/marking up of items of mailing in accordance with the present invention. In FIG. 4 an embodiment of a label 12 or pre-printed package such as an envelope 10 or a packet/parcel is depicted comprising an array pattern 14, herein shown in a broken line marked circle as it would appear if it is not filled out or not connected with straight lines for franking/marking up of items of mailing in accordance with the present invention.

The array pattern can appear as multiple arrays 14 as shown in FIG. 4 where the figures belonging to a mailers telephone number are indicated in the array pattern manually by the mailer or pre-printed by machinery for that purpose. It is realised that it is simple for scanning equipment to identify figures or other characters that are written in straight lines. This can be accomplished through pattern recognition, light line scanning, and the like. The broken line 16 in FIG. 4 symbolizes a line/beam of light from a scanner, and it is appreciated by the person skilled in the art that the filled in lines composing the figures in the telephone number, 0123456789, belonging to the mailer and the time for the calling of the distributor of items of mailing, here 11.00 a.m., in its entirety can be read via the inclined light line 16.

The time for mailing can be rounded or truncated within reasonable time periods, and it is utilized so that no one without permission can mark up an item of mailing with another mailers telephone number. Other codes can be utilized to mark up than a time. These can be received for instance when calling the distributor of post, which also applies to the time. Time or other codes are registered together with the telephone number, 0123456789, belonging to the mailer in a database at the distributor of post.

If the calling up is accomplished via a cellular phone, the mailer/customer can be invoiced as described, via for instance the telephone bill. Modern 2.5G and 3G telephones agree to connections with home pages/portals via for instance the communications protocols GPRS and WAP or the like. IP-telephony is also possible, whereby invoicing can be achieved in various known ways.

Cellular telephony and telephone booth telephones agrees to pre-paying of postage of items of mailing through pre paid cards comprising payment for a predetermined number of franking and values. Hereby, used franking is decremented via a database at the operator of the telephone system. In one embodiment it is comprised that the telephone card is a Subscriber Identity Modul Card (SIM) or similar meant to be inserted in a cellular phone. Alternatively, the payment information is in software downloaded in for instance the cellular phone via the telephone network operator when ordered by the mailer. The software can be downloaded to a SIM card or the like in accordance with known techniques.

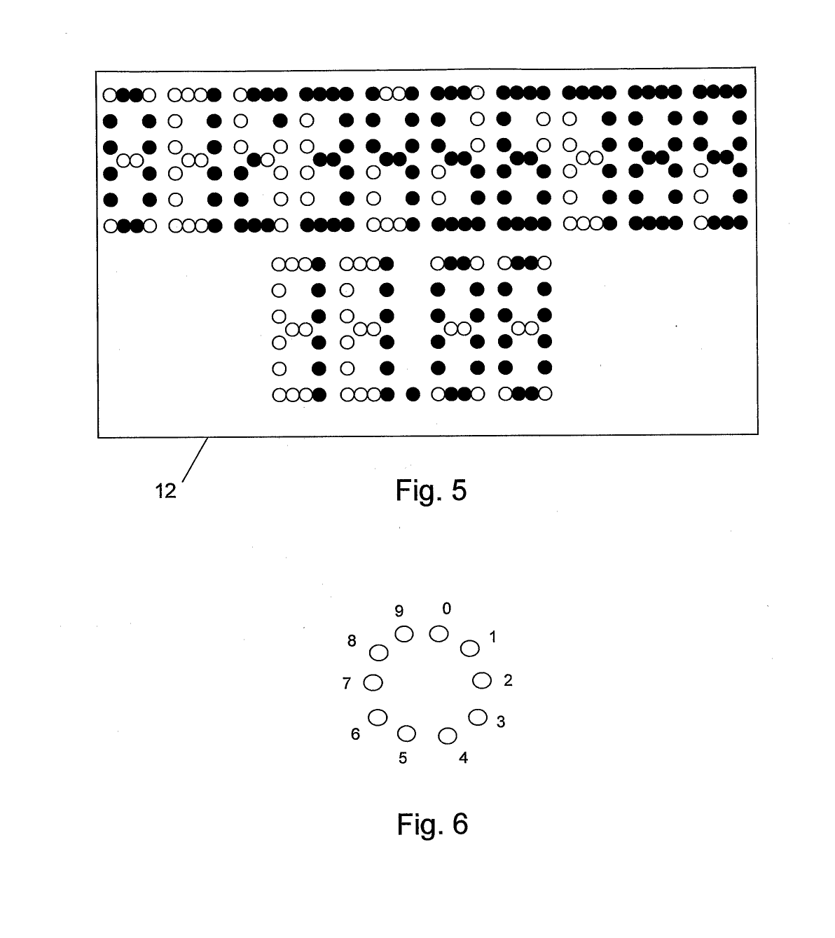

In FIG. 5 it is illustrated another embodiment of a label 12 or pre-printed on an item of mailing 10, comprising an array pattern 14 for franking/marking up of items of mailing in accordance with the present invention. Here, the figures in the mailers telephone number, 0123456789, and the time of calling 11.00 a.m. constituted by an array pattern 14 comprising none filled in dots. Dots are filled in with ink or the like to make up the figures in the telephone number. Hereby, a scanner is able to register the figures trough for instance pattern recognition or by other known methods.

The embodiment in FIG. 5, depicts that all the figures are marked up by different numbers of dots, whereby a figure can be identified by the number of filled in dots counted by a scanner for instance by measuring the reflectance or by other known methods. In FIG. 5, the figures 0-9 have the following number of filled in dots, which in accordance with the present invention is illustrated with the figure as an x-coordinate, and the number of filled in dots as y-coordinates according to (x, y), whereby the following result is achieved (0, 12), (1, 6), (2, 10), (3, 14), (4, 11), (5, 13), (6, 16), (7, 9), (8, 18) and (9, 15).

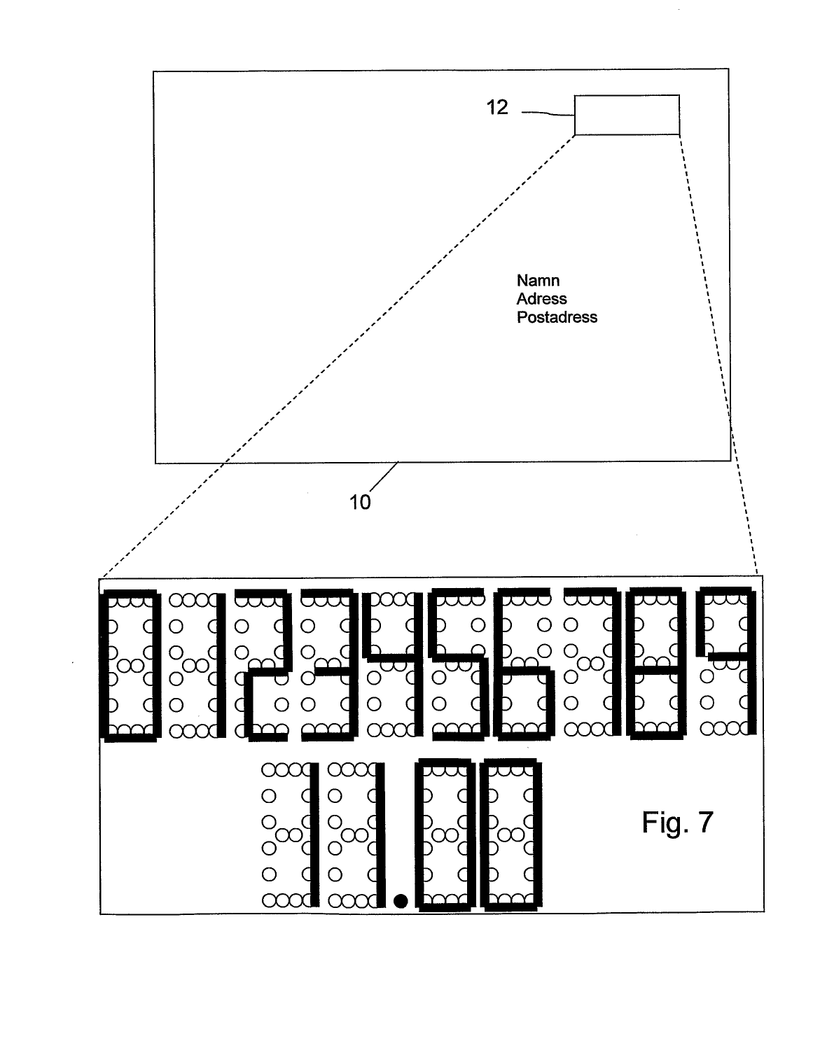

FIG. 6 illustrates a circular array with dots marked as 0, 1, 2, 3, 4, 5, 6, 7, 8, and 9 to be marked up with one digit in a telephone number or a code as in FIGS. 4 and 5, indicating the time for calling the administrator of mailing. The circular array can be multiplied in a pattern as accomplished in FIGS. 4 and 5.

The array pattern 14 in FIGS. 4 and 5 can be arranged with a different number of dots in every array, and not only as dots but as triangles, quadrants, rectangles and other possible geometrical forms.

FIG. 7 illustrates one embodiment of a package of mailing, for example, an envelope, comprising a label 12 with an array pattern 14 being adhered to an envelope 10 for franking/marking of items of mailing in accordance with the present invention. The labels 12 telephone number, 0123456789, is shown through a broken line blow up in FIG. 4. The package can be of any type of item of mailing such as an envelope, a packet/parcel, single page, post card or the like in accordance with the present invention.

Possibly also a user identity/UserID 38 can be stated. Password 36 and possibly UserID 38 could be utilized as entry to the intended data post in the database 50 in FIG. 5, but otherwise also data in accordance with the above may be stored in the data post.

In yet another embodiment it is possible to connect to a distributor of mails home page e.g. through Internet via a computer, where the mailer's information can be keyed to the database through prompting in the home page. Hereby an invoice has to be sent to the mailer at suitable time periods, or that payment is established via pay cards over the network or in another known manner, as the telephone is not utilized for registration in the database, if not the connection is established via a cellular phone. If the connection/calling is provided with a cellular phone, the mailer/customer is invoiced as before, via the telephone bill. Modern 2.5G and 3G telephones allow connection towards home pages via e.g. the communication protocol GPRS and WAP or the like. IP telephoning is also possible, whereby invoicing is accomplished by the distributor of mail.

Cellular telephoning and telephone boxes allow that the telephone bill for posting of items of mail can be bought and paid in advance through telephone cards comprising payment for a pre-determined number of franking and postage rates. Hereby, the used postage rate is decremented via a database at the operator of telephony. In one embodiment, it is comprised that the telephone bill is pre-paid through a telephone card connected to the mentioned pre-determined telephone number 14. Another embodiment comprises that the telephone card is a Subscriber Identity Module card (SIM) or the like intended to be comprised in a cellular phone. Alternatively, the payment information is in the shape of software which is downloaded into e.g. a cellular phone via the operator of the telephony by ordering from the mailer. The software can be downloaded into a SIM card or the like in accordance with known techniques.

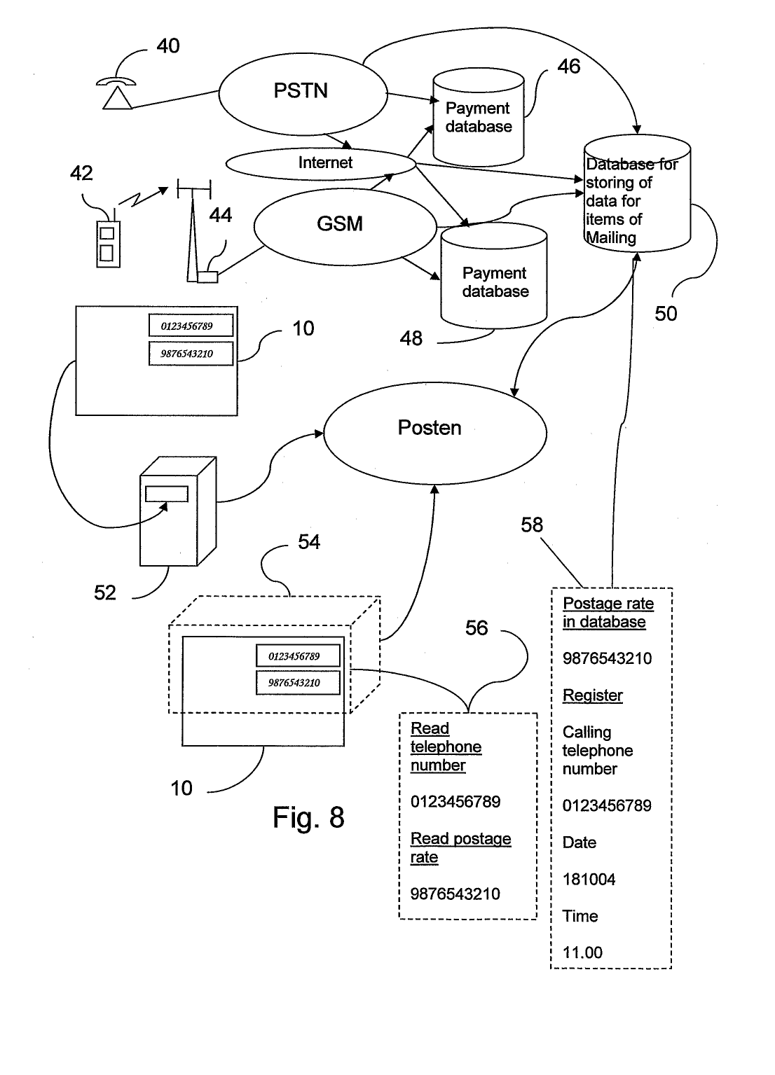

FIG. 8 schematically illustrates a system for franking/marking up of items of mail in accordance with the present invention. The arrows in FIG. 8 schematically indicate different communication routes in the system. The system comprises in one embodiment a mailers PSTN fitted telephone 40 or his/here cellular phone 42, which connect through the networks PSTN and GSM, respectively, or the like networks. The GSM telephone connects to the network via a base station 44 in a known manner. In each respectively network is a database 46, 48 for billing/debiting of telephone calls. The database 50 for storing of data for items of mailing for distribution of post, here Posten®, registers a mailers information when calling for franking via e.g. a “gateway” (not shown) in PSTN or GSM. When the calling by the mailer for registration has been accomplished, the item of mailing 10 is posted, e.g. in a post box 52. A scanner/reader 54 reads the letter for present data of franking, whereby data is matched/compared with data in the database 50, in accordance with for instance labelling data 56 for franking and the database 50 post 58 or in accordance with another manner as above.

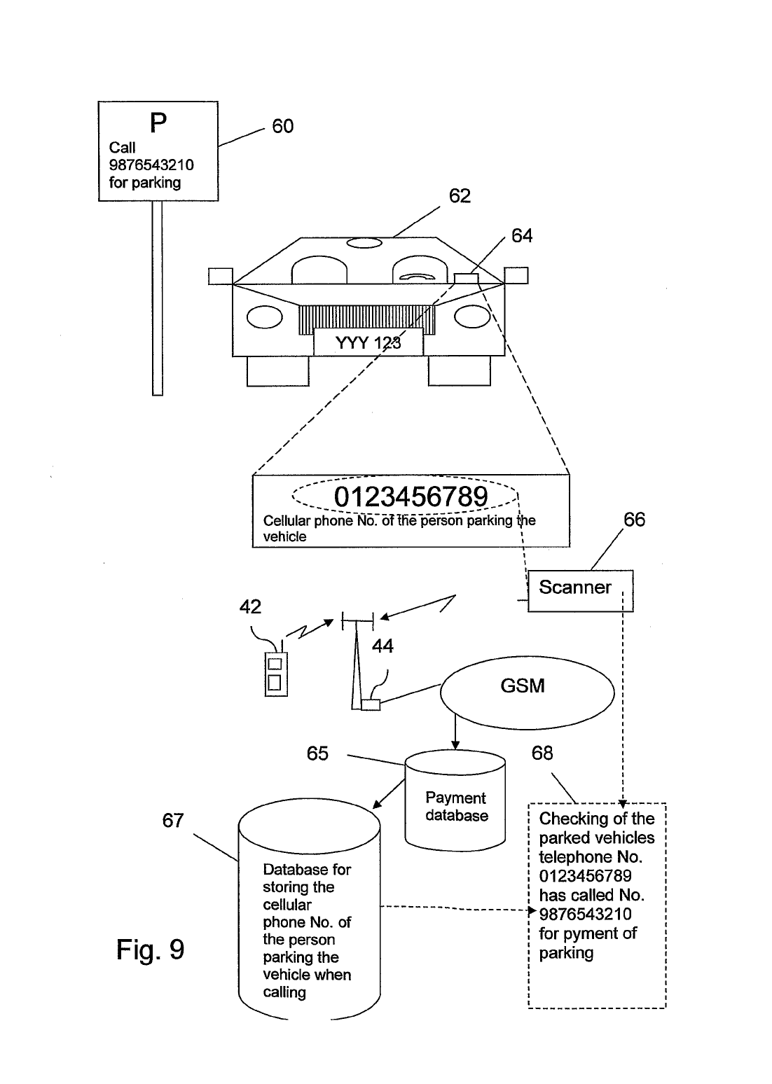

FIG. 9 schematically illustrates one embodiment of the present invention for payment of parking fees. A parking sign 60 provides where a vehicle 62 can park. In one embodiment a telephone number, 9876543210, is stated, which a person parking a vehicle can call with his cellular phone 42 via this persons cellular telephone number, 0123456789. Of course, the person parking can have pre knowledge from other sources, of the telephone number to call when parking. The base station 44 in GSM, 2.5G, 3G or other similar systems for cellular telephony registers the telephone call in a database 65 for payment, and in the database 67 for storing the cellular telephone number of the person parking at the administrator of parking payment. The connection between the administrators database and the telephone operator can be established via a “gateway” (not shown).

In order to provide parking of the vehicle 62 in a correct manner, the vehicle 62, at any spot on the vehicle, be provided a marking or label 64, preferably on a suitable spot inside the windscreen, which states a cellular telephone number, 0123456789, preferably belonging to the person driving the vehicle at the time for the parking. Through the call, the driver of the vehicle confirms parking a number of minutes, hours, days etc. A parking supervisor (not shown) with a suitable scanning apparatus 66 for instance a scanner, reads the label 64, and thus in that manner reads the telephone number, 0123456789, of the person parking.

Either an automatic calling is comprised to check that the cellular telephone number 0123456789 has called the database to register a parking a predetermined time via an inbuilt cellular radio function in the scanning apparatus 66, or alternatively, the parking supervisor utilizes a own cellular phone for checking, after the scanning apparatus has shown the telephone number.

When this is accomplished it is checked 68 that the scanned telephone number on the vehicle 64 has called the telephone number 9876543210 for a time determined parking. The time is either provided by pressing the push buttons on the cellular phone or via calling to a specific telephone number which indicates parking time. Of course, also the known function with a terminating call for parking can be used in the present payment parking system, so that long term parking can be terminated in an alternative embodiment.

As is apparent from the present description it is not at all required to utilize the vehicles license plate YYY 123 to identify a correct parking, and the parking can take place anywhere, without a subscription of parking. The only requirement is that the vehicle is provided a telephone number at some spot that should be debited via the phone bill or a separate invoice from the administrator of the parking, whereby it is also required that parking is provided with the cellular phone bearing the telephone number on the label 64. Of course, the vehicle license number or vehicle model can be stated when calling, to minimize fraud. Alternatively, the license number and/or vehicle model could be comprised in the label 64.

Parking in accordance with the present invention further provides the unique possibility to call from any distance whatsoever from the vehicle 62 to call and extend the time for parking, when the vehicle owner requires more parking time then first expected, i.e., the parking can be renewed or extended by again calling the parking administrators telephone number 9876543210 and key in the wanted further time for parking.

The present invention further provides an automatic debiting for payment of road customs when vehicles pass those and are to be registered for payment. When a vehicle passes a road custom and is to be registered for payment, the vehicle is marked 64 with a radio or IR radiating tag for registration of road custom payment at a receiver for the same. In greater details it can be accomplished in accordance with what is shown in FIG. 9.

The present road custom registration has the advantage that persons can call for payment long before the road custom has been passed, and non city inhabitants are only required to have a tag for instance on the inside of the windscreen of the vehicle 62, which they can order long before.

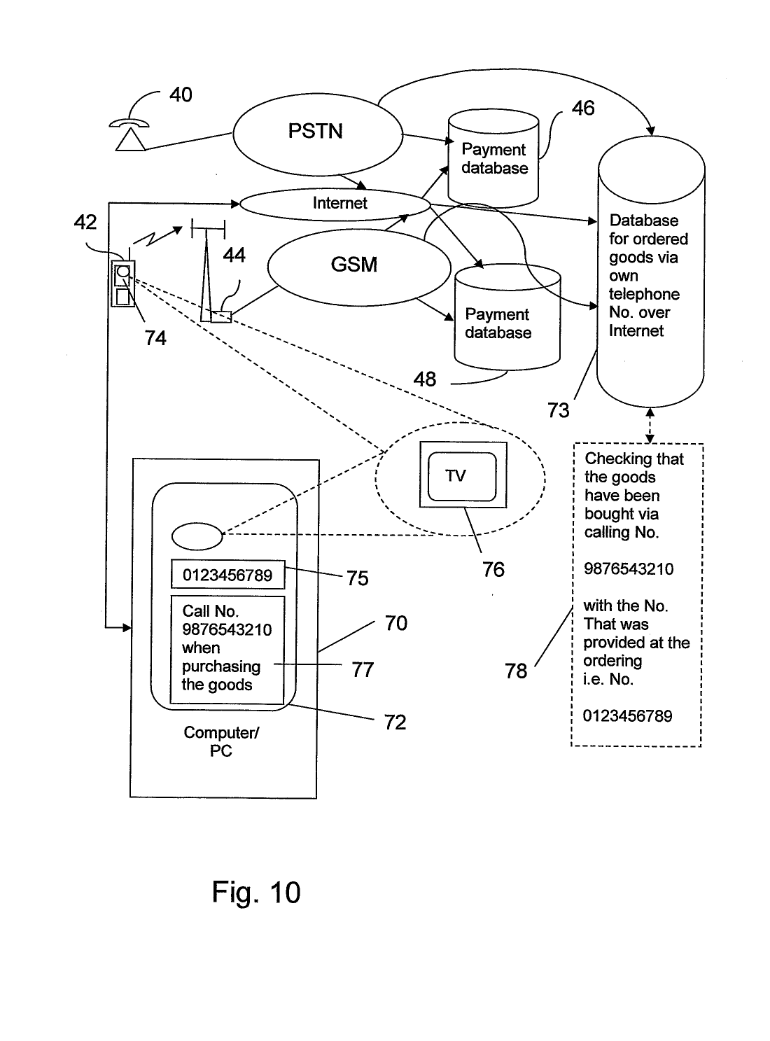

FIG. 10 schematically illustrates how a securer payment of goods and services over a network such as Internet is accomplished in accordance with the present invention. In the same manner as the present invention has described franking of items of mailing, and parking, it can be utilized to pay a purchase/payment of goods over a network such as Internet, either via a computer/PC 70 or a cellular phone 42 with an Internet connection. In the computers 70 display 72 or the cellular phones display 74 a goods or service is shown, which the owner of the telephone or computer 70 wishes to purchase by being connected to a home page for purchase of the same, herein a TV 76. The goods is shown in FIG. 7 through a broken line blow up, which either is shown on the computer display or the cellular phone display 72 and 74, respectively. A buyer of the goods, herein a TV, or the service push buttons in its telephone number, cellular or PSTN, when bying the TV 76 in a space or field 75 provided for that purpose via the computer 70 or cellular phone 42 in order to mark up a purchase of the goods 76 or service. Thereafter, the purchaser calls any of the telephone numbers being provided together with the goods for confirmation and payment with the cellular phone 42 or PSTN telephone 40. At the vendor with the home page it is thereafter checked that the purchaser of the TV has called any of the provided telephone numbers, 9876543210, corresponding to reference numeral 77 in the home page with that telephone number, 0123456789, the purchaser subscribes to. The call for the purchase is registered in the database 73 for ordered goods. At correspondence, the purchase is accomplished and the purchaser is invoiced via his/here telephone bill (“billing”) or via a separate invoice. In this manner, no credit card numbers are exchanged over the net and a “man-in-the-middle” can not parasite on the purchase.

The present invention also provides purchase by mortgage via Internet through specific telephone numbers in the home page are available to mortgage purchases to for instance 6, 12, 24, 36 months etc.

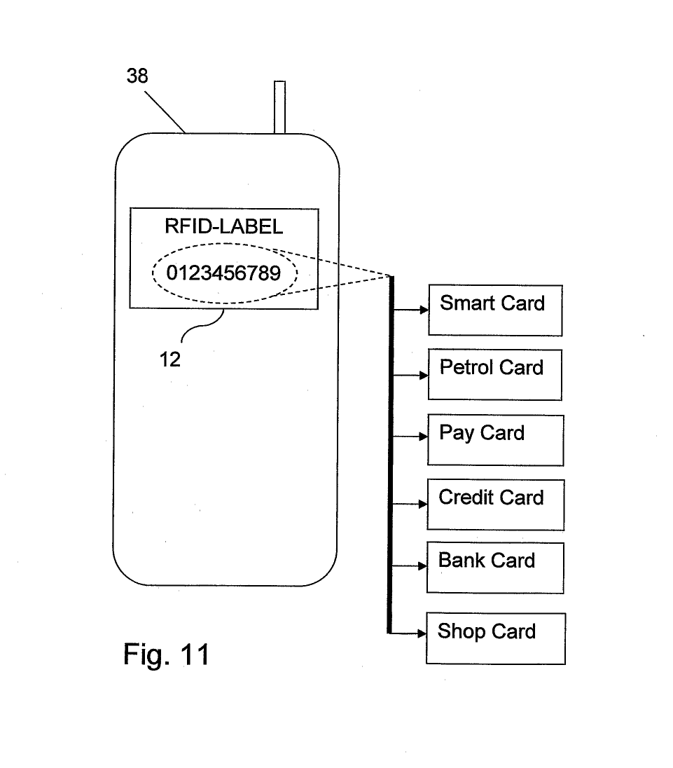

Moreover, the present invention provides a ticket less system for payment of travelling by bus, train, subway and the like by that the person travelling with the vehicles has marked 64 his/here cellular telephone with the cellular telephones own telephone number, 0123456789, depicted in FIG. 11, which is scanned when checking travelling. Payment is achieved as described before by calling the ticket provider's specific telephone number, 0987654321. It is thus possible to provide telephone numbers for a travelling ticket, weekly, monthly, annual etc. Alternatively, travelling alternatives are push buttoned when calling. It is appreciated by a person skilled in the art that the herein provided applications are relying on the principle of marking with an own telephone number calling with a specific number via the own telephone number and scanning of the own telephone number to check payment.

FIG. 11 schematically illustrates a cellular phone 38 marked with its own telephone number as an RFID label 12. Also linked to the unique telephone number is at least one card for payment. These cards are such as smart card, petrol card, pay card, credit card, bank card, or shop card and other like cards. Thus the telephone number in a database is connected to the invention conventionally being stored on a cards magnetic strip or smart cards CPU memory. In one embodiment the cellular phone 38 displays a 2D matrix, barcode, or the like in its display (not shown) comprising a PIN code. When the PIN code is held against a scanner when a merchandise or service is paid for, the PIN code opens for debiting the relevant card for the purchase. Hence, the cell-phone is utilized as a card as those mentioned.

The PIN code can be provided in other ways such as the scanner having push buttons or the like to provide the PIN code, or a special function attached to the cell-phone provides that the cell-phone buttons could be used to provide the PIN code to a scanner with an RF receiver. When this phone 38 is used to pay tickets it is possible to draw the ticket costs directly from a card connected to the telephone number, 0123456789.

In the following a brief discussion of how the magnetic strip of a card is constituted and how the PIN code feature works and about smart cards is described with information from www.howstuffswork.com.

Although different companies and stores have their own numbering systems, the ANSI Standard X4.13-1983 is utilized by most national credit-card systems.

Here, a brief discussion of how the numbers count. The first digit in a credit-card number recognizes the utilized system such as American Express, Diners Club, Visa, MasterCard and the likes. The structure of a card number is different between systems. Systems such as American Express card numbers start with 37, Carte Blanche and Diners Club with 38.

American Express digits three and four are type and currency, digits five through 11 are the account number, digit 12 through 14 are the card number within the account and digit 15 is a check digit. Visa digits two through six are the bank number, digits seven through 12 or seven through 15 are the account number and digit 13 or 16 is a check digit. For MasterCard digits two and three, two through four, two through five or two through six are the bank number, which is depending on whether digit two is a 1, 2, 3 or other. The digits after the bank number up through digit 15 are the account number, and digit 16 is a check digit.

The magnetic stripe on the back is often named “magstripe”. A magstripe reader can read the information on the three-track stripe comprised in the stripe. Information on the stripe consists of three tracks on the magstripe, whereby each track is about one-tenth of an inch wide. The ISO/IEC standard 7811, which is utilized by banks, specifies that track one is 210 bits per inch (bpi), holding 79 6-bit plus parity bit read-only characters. Track two is 75 bpi, and holds 40 4-bit plus parity bit characters, and track three is 210 bpi, and holds 107 4-bit plus parity bit characters. When utilizing the credit card only tracks one and two are important. Track three is a read/write track, including an encrypted PIN, country code, currency units and amount authorized, but this is not standardized. Information on track one is contained in two formats A, which is reserved for proprietary use of the card issuer, and B, which includes a start sentinel of one character, a format code, B, of one character of alpha only, a primary account number of up to 19 characters, a separator of one character, a country code of three characters, a name of two to 26 characters, another separator of one character, the expiration date or separator of four characters or one character, a discretionary data of enough characters to fill out the maximum record length of 79 characters in total, an end of one character, and a longitudinal redundancy check (LRC) of one character.

The format for track two, developed by the banking industry, is start of one character, primary account number of up to 19 characters, separator of one character, country code of three characters, expiration date or separator of four characters or one character, discretionary data of enough characters to fill out the maximum record length of 40 characters total, and a LRC of one character.

Card Authentication is accomplished through three basic methods for determining whether a credit card will pay for a debiting. Merchants with few transactions each month do voice authentication using a touch-tone phone. Electronic data capture (EDC) magstripe-card swipe terminals are becoming more common as swiping of a card at a checkout, and finally virtual terminals on the Internet.

After a cashier swipes the credit card through a reader, the EDC software at the point-of-sale (POS) terminal dials a stored telephone number, using a modem, to call an acquirer. An acquirer is an organization that collects credit-authentication requests from merchants and provides the merchants with a payment guarantee. When the acquirer company receives the credit-card authentication request, the transaction is checked for validity and the record on the magstripe for a merchant ID, a valid card number, expiration date, credit-card limit, card usage.

Single dial-up transactions are processed at 1,200 to 2,400 bits per second (bps), while direct Internet access uses much higher speeds via this protocol. In this system, a cardholder enters a personal identification number (PIN) using a keypad. The PIN code is not comprised on the card, but it is encrypted in a database. For example, before receiving cash from an ATM, the ATM encrypts the PIN and sends it to the database to see if there is a match. The PIN can be either in a bank's computers in an encrypted form as a cipher or encrypted on the card itself. The transformation used in this type of cryptography is called one-way. This means that it is not easy to compute a cipher given the bank's key and the customer's PIN, but not computationally feasible to obtain the plain-text PIN from the cipher, even if the key is known. This feature was designed to protect a cardholder from being impersonated by someone who has access to the bank's computer files. ATMs keep personal identification number PIN and other information safe by using encryption software such as Triple DES (Data Encryption Standard).

Likewise, the communications between an ATM and a bank's central computer are encrypted to prevent from tapping into the phone lines, recording the signals sent to the ATM to authorize the dispensing of cash and then feeding the same signals to the ATM to trick it into unauthorized dispensing of cash.

Now there exist cards that utilize even more security measures than a conventional credit card so called smart cards. Smart card is an application that involves all aspects of cryptography, not only the authentication described above. A smart card has a microprocessor built into the card itself. Cryptography is essential to the functioning of these cards.

As an additional embodiment debiting for goods 10, 76 can be debited via the caller's telephone number, so called “billing”.

Checking means in the system of the present invention can for instance be software for matching or another known means for the same.

As franking, parking, and purchases over networks are founded on the principle of marking up a telephone number on an item and call with the marked up number, it is understood by the person skilled in the art that many of the embodiments described for franking also can utilized when parking, road customs, payment of tickets, and purchase over networks such as Internet, without being specifically mentioned when describing the same.

Further embodiments of the present invention are apparent to a person skilled in the art through the attached claims.

1. A method relating to payment and granting of postage rate for items of mailing through at least one of a network for data- and telecommunication wherein an item of mailing is marked up with a telephone number (0123456789) on which a mailer subscribes to, and that the mailer calls a predetermined telephone number belonging to the distributor of the items of mailing, confirming by the predetermined telephone number the payment of an item of mailing at the distributor, whereby said calling is registered in a database for distribution of mail associated to the predetermined telephone number (9876543210) and to the telephone number of the mailer, said items of mail read by a machinery during distribution where data registered in said database through the mailers telephone number is checked for correspondence with data marked up and read on the item of mailing regarding postage rate and payment, by correspondence between data, the item of mailing being granted for distribution.

2. A method according to claim 1, wherein the marking up of an item of mailing consists of a pattern in an array or matrix to be filled in with said mailers telephone number.

3. A method according to claim 2, wherein it comprises that the array or matrix pattern is further marked up with the time or other received code for the calling by the mailer with the mailers telephone number.

4. A method according to claim 2, wherein that the array or matrix pattern is comprised by markings to be filled in, which when they are filled in resemble the telephone number which the mailer subscribes to.

5. A method according to claim 2, wherein the filled in markings are different in number for every figure between zero to nine so that the figures are identified by the number of filled in markings through pattern recognition or differences in reflectance when scanned.

6. A method according to claim 2, wherein the array or matrix pattern consists of markings to be filled in or filled in markings, which when they are combined by straight lines resembles the telephone number subscribed to by the mailer.

7. A method according to claim 6, wherein the scanner is a light beam scanner, whereby the beam is inclined in such a manner that both perpendicular and transversal lines are registered in its entirety when the scanner beam is moved over the array pattern.

8. A method according to claim 1, wherein different postage rates for mailing have there own predetermined telephone number which is called by the mailer for posting.

9. A method according to claim 1, wherein said item of mailing is marked up with data pre-printed in the shape of an EAN code or like code for machinery reading.

10. A method according to claim 1, wherein the telephone number of the mailer is an IP telephony number.

11. A method according to claim 1, wherein stacks of multiple items of mailing are replacing the franking machine.

12. A system relating to payment and granting of postage rate for items of mailing through at least one of a network for data- and telecommunication wherein it comprises:
an item of mailing is marked up with a telephone number on which a mailer subscribes to, and that the mailer calls a predetermined telephone number belonging to the distributor of the items of mailing, confirming by the predetermined telephone number the payment of an item of mailing at the distributor;
said calling is registered in a database for distribution of mail associated to the predetermined telephone number and to the telephone number of the mailer; and
said items of mailing read by a machinery during distribution where data registered in said database through the mailers telephone number is checked for correspondence with data marked up and read on the item of mail regarding postage rate and payment, by correspondence between data, the item of mailing being granted for distribution.

13. A system according to claim 12, wherein the marking up of an item of mailing consists of a pattern in an array or matrix to be filled in with said mailers telephone number.

14. A system according to claim 13, wherein comprises that the array or matrix pattern is further marked up with the time or other received code for the calling by the mailer with the mailers telephone number.

15. A system according to claim 13, wherein that the array or matrix pattern is comprised by markings to be filled in, which when they are filled in resemble the telephone number which the mailer subscribes to.

16. A system according to claim 13, wherein the filled in markings are different in number for every figure between zero to nine so that the figures are identified by the number of filled in markings through pattern recognition or differences in reflectance when scanned.

17. A system according to claim 13, wherein the array or matrix pattern consists of markings to be filled in or filled in markings, which when they are combined by straight lines resembles the telephone number subscribed to by the mailer.

18. A system according to claim 17, wherein the scanner is a light beam scanner, whereby the beam is inclined in such a manner that both perpendicular and transversal lines are registered in its entirety when the scanner beam is moved over the array pattern.

19. A system according to claim 13, wherein different postage rates for mailing have there own predetermined telephone number which is called by the mailer for posting.

20. A system according to claim 12, wherein said item of mailing is marked up with data pre-printed in the shape of an EAN code or like code for machinery reading.

21. A system according to claim 12, wherein the telephone number of the mailer is an IP telephony number.

22. A system according to claim 12, wherein stacks of multiple items of mailing are replacing the franking machine.

23. A package for items of mailing regarding payment and granting of postage for items of mailing through at least one of a network for data and telecommunication, wherein said package is marked with an array pattern intended for filling in a telephone number, which a mailer subscribes to, with figures, visible to the human eyes, and identifiable for machine scanning, whereby said telephone number identifies a mailer by the same telephone number being stored in a database at a distributor of items of mailing.

24. A package according to claim 23, wherein the marking up of an item of mailing consists of a pattern in an array or matrix to be filled in with said mailers telephone number.

25. A package according to claim 23, wherein it comprises that the array or matrix pattern is further marked up with the time or other received code for the calling by the mailer with the mailers telephone number.

26. A package according to claim 23, wherein that the array or matrix pattern is comprised by markings to be filled in, which when they are filled in resemble the telephone number which the mailer subscribes to.

27. A package according to claim 24, wherein the filled in markings are different in number for every figure between zero to nine so that the figures are identified by the number of filled in markings through pattern recognition or differences in reflectance when scanned.

28. A package according to claim 24, wherein the array or matrix pattern consists of markings to be filled in or filled in markings, which when they are combined by straight lines resembles the telephone number subscribed to by the mailer.

29. A package according to claim 23, wherein the scanner is a light beam scanner, whereby the beam is inclined in such a manner that both perpendicular and transversal lines are registered in its entirety when the scanner beam is moved over the array pattern.

30. A package according to claim 23, wherein different postage rates for mailing have there own predetermined telephone number which is called by the mailer for posting.

31. A package according to claim 23, wherein said item of mailing is marked up with data pre-printed in the shape of an EAN code or like code for machinery reading.

32. A package according to claim 23, wherein the telephone number of the mailer is an IP telephony number.
